(19) United States
(12) Patent Application Publication
(10) Pub. No.: US 2026/0072140 A1
(43) Pub. Date: Mar. 12, 2026

(54) LiDAR device, scanning unit, vehicle, and feature information determination method

(71) Applicant: RAYZ TECHNOLOGIES CO., LTD., Yancheng (CN)

(72) Inventors: Detao DU, Yancheng,Jiangsu (CN); Ruxin CHEN, Yancheng,Jiangsu (CN)

(21) Appl. No.: 19/257,569

(22) Filed: Jul. 2, 2025

(30) Foreign Application Priority Data
Jul. 4, 2024 (CN) 2024108965548

(51) Int. Cl. G01S 7/481; G01S 7/484; G01S 17/10; G01S 17/931; G02B 26/08; G02B 26/10; G02B 26/12

(52) U.S. Cl. CPC G01S 7/4817; G01S 7/484; G01S 17/10; G02B 26/0833; G02B 26/105; G02B 26/124; G01S 17/931

(57) ABSTRACT

The present disclosure relates to the technical field of detection, and in particular to a LiDAR device, a scanning unit and a vehicle. The LiDAR device includes a light emitting module, a scanning unit, a light receiving module, and a processing unit, wherein the scanning unit at least includes a polyhedral rotating mirror that rotates around a rotation axis, a first light signal is reflected towards a to-be-detected target scene by a first reflecting mirror surface, a second light signal reflected by a target object in the to-be-detected target scene is reflected by a second reflecting mirror surface to finally reach a light receiving unit, the first reflecting mirror surface has a first inclination angle, the second reflecting mirror surface has a second inclination angle, and the first inclination angle is different from the second inclination angle.

### FIELD

The present disclosure relates to the technical field of detection, and in particular to a LIDAR device, a scanning unit, a vehicle, and a feature information determination method.

### BACKGROUND

With the development of applications such as autonomous driving, assisted driving, 3D audio-video and game boxes, smartphone navigation, and smart robots, real-time and accurate acquisition of distance information of target scenes has become increasingly important. LiDAR is a radar system that detects a position, speed and other feature parameters of a target by emitting a laser beam, and a working principle thereof is that a detection laser beam is firstly emitted to a target scene, then, a received signal reflected back from the target is compared with an emitted signal, and after appropriate processing, relevant information of the target, such as distance, azimuth, altitude, speed, posture and even shape parameters of the target, can be obtained.

LIDAR requires a relatively large field of view and a relatively small angular resolution for scanning and detection in both horizontal and vertical directions. It is difficult for existing LIDAR devices to provide a sufficient scanning resolution and scanning field of view.

### SUMMARY

In view of the above-mentioned problems, the present disclosure is proposed. The present disclosure provides a LiDAR device, a scanning unit, a vehicle, and a feature information determination method.

According to one aspect of the present disclosure, provided is a LIDAR device, including at least one light emitting module composed of one or more light emitting units, at least one scanning unit, at least one light receiving module composed of one or more light receiving units, and a processing unit; at least one light emitting unit in the at least one light emitting module being configured to emit a first light signal; the scanning unit at least including a polyhedral rotating mirror that rotates around a rotation axis, the polyhedral rotating mirror having a plurality of reflecting mirror surfaces, the first light signal being reflected towards a to-be-detected target scene by a first reflecting mirror surface among the plurality of reflecting mirror surfaces, a second light signal reflected by a target object in the to-be-detected target scene being reflected by a second reflecting mirror surface among the plurality of reflecting mirror surfaces to finally reach at least one light receiving unit in the at least one light receiving module, and during any received and emitted light detection, a light receiving field of view to which all the light receiving units in the at least one light receiving module can correspond being greater than a light receiving field of view to which all the light emitting units in the at least one light emitting module can correspond; the at least one light receiving unit being configured to convert the received second light signal into a detection signal; and the processing unit being configured to determine feature information of the target object based on the detection signal, the feature information at least including distance information and/or reflectivity information of the target object, wherein an angle between each of the reflecting mirror surfaces and the rotation axis is an inclination angle of the reflecting mirror surface, the first reflecting mirror surface has a first inclination angle, the second reflecting mirror surface has a second inclination angle, and the first inclination angle is different from the second inclination angle.

Furthermore, for the LIDAR device according to one aspect of the present disclosure, an intersection line of the first reflecting mirror surface and a vertical cross section of the rotation axis is perpendicular to an intersection line of the second reflecting mirror surface and the vertical cross section of the rotation axis.

Furthermore, for the LiDAR device according to one aspect of the present disclosure, the plurality of light receiving units are arranged in an area array, wherein parts of the light receiving units arranged along a curve are disposed in a working mode, and at least one light receiving unit is disposed in a non-working mode.

Furthermore, for the LiDAR device according to one aspect of the present disclosure, the at least one light receiving module includes a first light receiving module and a second light receiving module, the first light receiving module is disposed on a first side relative to the scanning unit, the second light receiving module is disposed on a second side relative to the scanning unit, and the first side is different from the second side; and light emitted by at least one of the light emitting units is at least partially received by the first light receiving module and is at least partially received by the second light receiving module.

Furthermore, for the LiDAR device according to one aspect of the present disclosure, the at least one light emitting module includes a first light emitting module and a second light emitting module, the first light emitting module is disposed on a first side relative to the scanning unit, and the second light emitting module is disposed on a second side relative to the scanning unit; and at least one of the light receiving units receives at least part of emitted light from the first light emitting module and is also capable of receiving at least part of emitted light from the second light emitting module.

Furthermore, for the LiDAR device according to one aspect of the present disclosure, an inclination angle difference of adjacent reflecting mirror surfaces among the plurality of reflecting mirror surfaces is a predetermined value.

Furthermore, for the LiDAR device according to one aspect of the present disclosure, the scanning unit further includes at least one micro-electro-mechanical system micromirror, and a scanning direction of the at least one micro-electro-mechanical system micromirror is different from a scanning direction of the polyhedral rotating mirror.

Furthermore, the LiDAR device according to one aspect of the present disclosure further includes a prism unit disposed between the at least one light emitting module and the scanning unit and configured to adjust a direction in which the first light signal is incident on the scanning unit.

Furthermore, for the LiDAR device according to one aspect of the present disclosure, the number of the light receiving units in the at least one light receiving module is greater than the number of the light emitting units in the at least one light emitting module.

Furthermore, for the LiDAR device according to one aspect of the present disclosure, a first light emitting unit in the at least one light emitting module emits the first light signal, the first light signal is reflected towards the to-be-detected target scene by the first reflecting mirror surface among the plurality of reflecting mirror surfaces, and the second light signal reflected by the target object in the to-be-detected target scene is reflected by the second reflecting mirror surface to finally reach the first light receiving unit in the at least one light receiving module; wherein the correspondence between the first light emitting unit and the first light receiving unit is determined by the first inclination angle of the first reflecting mirror surface and the second inclination angle of the second reflecting mirror surface.

Furthermore, for the LiDAR device according to one aspect of the present disclosure, the processing unit receives external control signals from the outside of the LiDAR device and controls one or more of light emitting time, angle, intensity, code and comparator photoelectric threshold for the second light signal of the at least one light emitting unit based on the external control signals.

Furthermore, the LiDAR device according to one aspect of the present disclosure further includes at least one code wheel unit configured to output angle information corresponding to the light emitting time of the at least one light emitting unit.

Furthermore, for the LiDAR device according to one aspect of the present disclosure, the external control signals are provided by vehicle-related controllers.

Furthermore, for the LiDAR device according to one aspect of the present disclosure, parts of light emitting module control signals of the light emitting module are obtained by performing unified calculation and processing on at least three second light signals in a local area in the target scene, wherein a time interval of at least two second light signals is greater than one-fifth of one-frame scanning time, and the local area is smaller than a preset local proportion (such as 1/10, 1/100, and 1/10000) of the target scene; the unified calculation includes calculation performed by using a neural network; and the parts of light emitting module control signals control at least one of the following contents: emitting time, light intensity, angle, multi-pulse interval, waveform and code of each light emitting unit.

Furthermore, for the LiDAR device according to one aspect of the present disclosure, the unified calculation is provided by the vehicle-related controllers.

According to another aspect of the present disclosure, provided is a scanning unit, including a polyhedral rotating mirror that rotates around a rotation axis, the polyhedral rotating mirror having a plurality of reflecting mirror surfaces, a first light signal being reflected towards a to-be-detected target scene by a first reflecting mirror surface among the plurality of reflecting mirror surfaces, and a second light signal reflected by a target object in the to-be-detected target scene being reflected by a second reflecting mirror surface among the plurality of reflecting mirror surfaces; wherein an angle between each of the reflecting mirror surfaces and a plane perpendicular to the rotation axis is an inclination angle of the reflecting mirror surface, the first reflecting mirror surface has a first inclination angle, the second reflecting mirror surface has a second inclination angle, and the first inclination angle is different from the second inclination angle.

Furthermore, for the scanning unit according to another aspect of the present disclosure, an intersection line of the first reflecting mirror surface and a vertical cross section of the rotation axis is perpendicular to an intersection line of the second reflecting mirror surface and the vertical cross section of the rotation axis.

Furthermore, for the scanning unit according to another aspect of the present disclosure, an inclination angle difference of adjacent reflecting mirror surfaces among the plurality of reflecting mirror surfaces is a predetermined value.

Furthermore, the scanning unit according to another aspect of the present disclosure further includes at least one micro-electro-mechanical system micromirror, and a scanning direction of the at least one micro-electro-mechanical system micromirror is different from a scanning direction of the polyhedral rotating mirror.

According to a further aspect of the present disclosure, provided is a vehicle, including the LiDAR device as described above.

According to a yet further aspect of the present disclosure, provided is a feature information determination method, including: emitting a first light signal by at least one light emitting unit in at least one light emitting module, the first light signal being reflected towards a to-be-detected target scene by a first reflecting mirror surface of a polyhedral rotating mirror in a scanning unit, and a second light signal reflected by a target object in the to-be-detected target scene being reflected by a second reflecting mirror surface to finally reach at least one light receiving unit in at least one light receiving module; converting the received second light signal into a detection signal by the at least one light receiving unit; and determining feature information of the target object based on the detection signal, the feature information at least including distance information and/or reflectivity information of the target object, wherein an angle between each reflecting mirror surface of the polyhedral rotating mirror and a rotation axis of the polyhedral rotating mirror is an inclination angle of the reflecting mirror surface, the first reflecting mirror surface has a first inclination angle, the second reflecting mirror surface has a second inclination angle, and the first inclination angle is different from the second inclination angle.

As will be described in detail below, in the LiDAR device, the scanning unit, the vehicle, and the feature information determination method according to the embodiments of the present disclosure, by using the reflecting mirror surfaces with the different inclination angles to reflect emitted light and received light, the number of scanning lines more than light sources is achieved by utilizing relatively few laser sources, moreover, the receiving area of the polyhedral rotating mirror is utilized to the maximum extent, the signal intensity is enhanced, and the ranging capability of LiDAR is improved.

### BRIEF DESCRIPTION OF DRAWINGS

The above-mentioned and other objects, features and advantages of the present disclosure will become more apparent by describing the embodiments of the present disclosure in more detail in conjunction with the accompanying drawings. The accompanying drawings are provided for further understanding the embodiments of the present disclosure, and constitute a part of the description. They serve to explain the present disclosure in conjunction with the embodiments of the present disclosure, rather than to limit the present disclosure. In the accompanying drawings, the same reference numerals usually represent the same components or steps.

FIG. 1A and FIG. 1B are schematic diagrams for illustrating a vehicle according to an embodiment of the present disclosure;

FIG. 2 is a block diagram for illustrating the configuration of a LiDAR device according to an embodiment of the present disclosure;

FIG. 3 is a schematic diagram for further illustrating a ranging scene of a LIDAR device according to an embodiment of the present disclosure;

FIG. 4A to FIG. 4C are schematic diagrams for illustrating a scanning unit according to an embodiment of the present disclosure;

FIG. 5 is a schematic diagram for further illustrating a ranging scene of a LIDAR device according to an embodiment of the present disclosure;

FIG. 6 is a block diagram for further illustrating the configuration of a LiDAR device according to an embodiment of the present disclosure;

FIG. 7 is a block diagram for further illustrating the configuration of a LIDAR device according to an embodiment of the present disclosure;

FIG. 8 is a schematic diagram for further illustrating a ranging scene of a LiDAR device according to an embodiment of the present disclosure;

FIG. 9 is a schematic diagram for further illustrating a ranging scene of a LIDAR device according to an embodiment of the present disclosure; and

FIG. 10 is a flow diagram for illustrating a feature information determination method according to an embodiment of the present disclosure.

### DETAILED DESCRIPTION

In order to make the objects, technical solutions and advantages of the present disclosure more apparent, exemplary embodiments according to the present disclosure will be described in detail below with reference to the accompanying drawings. Apparently, the described embodiments are only a part of the embodiments of the present disclosure, not all the embodiments. It should be understood that the present disclosure is not limited by the exemplary embodiments described herein.

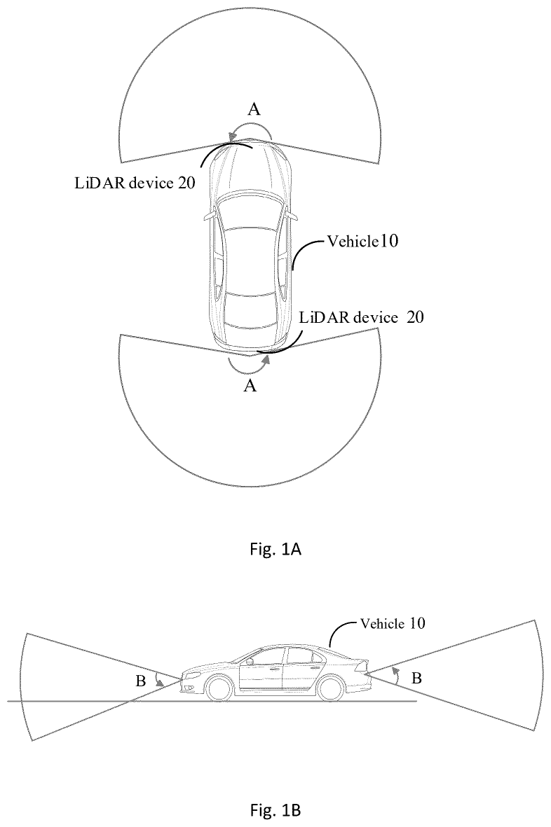

FIG. 1A and FIG. 1B are schematic diagrams for illustrating a vehicle according to an embodiment of the present disclosure. As shown in FIG. 1A and FIG. 1B, the vehicle 10 according to the embodiment of the present disclosure is equipped with a LiDAR device 20 according to an embodiment of the present disclosure. It is easy to understand that those equipped with the LiDAR device 20 according to the embodiment of the present disclosure are not limited to the vehicle, and the LiDAR device 20 can be applied to various scenes requiring distance measurement and feature information acquisition, such as material monitoring in a production process, robot navigation and obstacle avoidance, environmental monitoring, autonomous driving, traffic flow monitoring and vehicle counting, 3D scanning and measurement, and virtual reality (VR) and augmented reality (AR) applications.

Specifically, as shown in FIG. 1A and FIG. 1B, LiDAR devices 20 according to the embodiment of the present disclosure are disposed on front and rear ends of the vehicle 10. The number and position of the LiDAR devices 20 can be disposed as required, but are not limited. As shown in FIG. 1A, the LiDAR device 20 has a horizontal field of view, such as angle A, in the horizontal direction; and as shown in FIG. 1B, the LiDAR device 20 has a vertical field of view, such as angle B, in the vertical direction. Below, the specific configuration of the LIDAR device 20 according to the embodiment of the present disclosure and the feature information determination method in which the LiDAR device 20 is used will be further described in detail with reference to the accompanying drawings.

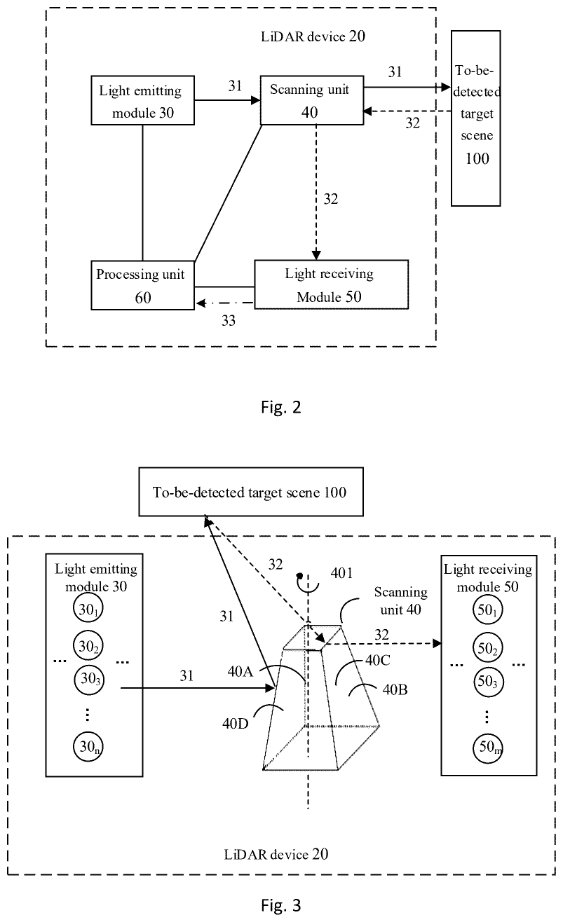

FIG. 2 is a block diagram for illustrating the configuration of a LiDAR device according to an embodiment of the present disclosure. As shown in FIG. 2, the LiDAR device 20 according to the embodiment of the present disclosure includes a light emitting module 30, a scanning unit 40, a light receiving module 50, and a processing unit 60. A first light signal 31 emitted by the light emitting module 30 is scanned by the scanning unit 40 and is then emitted towards a to-be-detected target scene 100, and a second light signal 32 reflected by a target object in the to-be-detected target scene 100 is reflected again towards the light receiving module 50 by the scanning unit 40. The light receiving module 50 converts the second light signal 32 into a detection signal 33. The processing unit 60 determines feature information of the target object based on the detection signal 33, and the feature information at least includes distance information and/or reflectivity information and the like of the target object. Furthermore, the processing unit 60 receives external control signals from the outside of the LIDAR device 20 and controls one or more of light emitting time, angle, intensity, code and comparator photoelectric threshold for the second light signal 32 of the light emitting unit in the light receiving module 50 based on the external control signals. The external control signals are provided by vehicle-related controllers, for example. Parts of the light emitting module control signals of the light emitting module are obtained by performing unified calculation and processing on at least three second light signals in a local area in the target scene, wherein a time interval of at least two second light signals is greater than one-fifth of the one-frame scanning time, and the local area is smaller than a preset local proportion (such as 1/10, 1/100, and 1/10000) of the target scene. The unified calculation includes calculation performed by using a neural network; and the parts of light emitting module control signals control at least one of the following contents: emitting time, light intensity, angle, multi-pulse interval, waveform and code of each light emitting unit.

FIG. 3 is a schematic diagram for further illustrating a ranging scene of a LIDAR device according to an embodiment of the present disclosure. It is easy to understand that the processing unit 60 is omitted in FIG. 3 and subsequent schematic diagrams in order to simplify the description.

As shown in FIG. 3, the light emitting module 30 includes one or more light emitting units 30₁, 30₂, . . . 30ₙ, and the light receiving module 50 includes one or more light receiving units 50₁, 50₂, . . . 50ₘ, n and m are natural numbers greater than or equal to 2, and n and m can be the same or different. The number of the light emitting units in the light emitting module 30 and the number of the light receiving units in the light receiving module 50 are nonrestrictive. In one embodiment of the present disclosure, the number m of the light receiving units is greater than the number n of the light emitting units.

The light emitting units in the light emitting module 30 and the light receiving units in the light receiving module 50 can be in one-dimensional linear arrangement or arranged in an area array. The light emitting unit may be a fiber laser, a semiconductor laser (such as a laser diode (LD) or a vertical cavity surface emitting laser (VCSEL)), a gas laser, or a solid-state laser and the like. The LD or the VCSEL can achieve output in free space or through fiber coupling, and during specific implementation, the type and beam output way of the light emitting unit can be selected according to actual conditions, and are not limited in the present disclosure. Furthermore, the light emitting unit may also include a lens group disposed on a light emitting surface of the light emitting unit and configured to adjust a light spot of the first light signal 31 emitted by the light emitting unit. The light receiving unit may include a light receiving component and a photoelectric conversion component (unshown), for example. The light receiving component is configured to receive the second light signal 32, and the photoelectric conversion component converts the second light signal 32 into the corresponding detection signal 33, such that the processing unit 60 determines the feature information of the target object.

Furthermore, as shown in FIG. 3, the scanning unit 40 at least includes a polyhedral rotating mirror that rotates around a rotation axis 401, and the polyhedral rotating mirror has a plurality of reflecting mirror surfaces. In an example shown in FIG. 3, the polyhedral rotating mirror has four reflecting mirror surfaces 40A, 40B, 40C, and 40D. It should be understood that the number of the reflecting mirror surfaces of the polyhedral rotating mirror is nonrestrictive. In one embodiment of the present disclosure, the cross section of the polyhedral rotating mirror is of a regular polygon, and the number of sides of the regular polygon is an integer multiple of 4, that is, the number of the reflecting mirror surfaces of the polyhedral rotating mirror can be an integer multiple of 4.

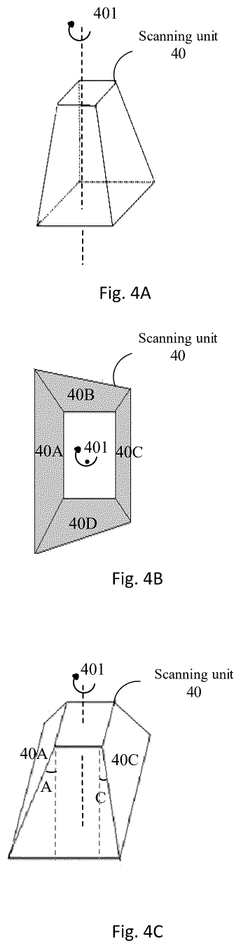

The scanning unit 40 is described with further reference to FIG. 4A to FIG. 4C. An angle between each of the reflecting mirror surfaces 40A, 40B, 40C, and 40D and the rotation axis 401 is an inclination angle A, B, C, or D of the reflecting mirror surface (for example, in a view direction in FIG. 4C, the inclination angles A and C of the reflecting mirror surfaces 40A and 40C are shown). In the embodiments of the present disclosure, the inclination angles A, B, C, and D of the reflecting mirror surfaces may be the same or different from each other. Specifically, an inclination angle difference (a difference of A and B) of adjacent reflecting mirror surfaces (such as 40A and 40B) among the plurality of reflecting mirror surfaces is a predetermined value. Furthermore, as shown in FIG. 4B, an intersection line of the first reflecting mirror surface 40A and a perpendicular cross section of the rotation axis is perpendicular to an intersection line of the second reflecting mirror surface 40B and the perpendicular cross section of the rotation axis.

The first light emitting unit (such as the light emitting unit 303) in the light emitting module 30 emits the first light signal 31, the first light signal 31 is reflected towards the to-be-detected target scene 100 by the first reflecting mirror surface 40A among the plurality of reflecting mirror surfaces, and the second light signal 32 reflected by the target object in the to-be-detected target scene 100 is reflected towards the first light receiving unit (such as the light receiving unit 50₂) in the light receiving module 50 by the second reflecting mirror surface 40B. That is, the correspondence between the first light emitting unit 303 and the first light receiving unit 50₂ is determined by the first inclination angle A of the first reflecting mirror surface 40A and the second inclination angle B of the second reflecting mirror surface 40B. By controlling a rotation speed of the scanning unit 40 and matching the preset inclination angles of the reflecting mirror surfaces, the field of view covered by the LiDAR device 20 is enlarged. During any received and emitted light detection, a light receiving field of view to which all the light receiving units 50₁, 50₂, . . . 50m in the at least one light receiving module 50 can correspond is greater than a light receiving field of view to which all the light emitting units 30₁, 30₂, . . . 30ₙ in the at least one light emitting module 30 can correspond, and the number m of the light receiving units is greater than the number n of the light emitting units.

In the LiDAR device according to the embodiment of the present disclosure, by presetting the different inclination angles of the plurality of reflecting mirror surfaces of the scanning unit, and controlling and using the reflecting mirror surfaces with the different inclination angles to reflect emitted light and received light, the receiving area of the polyhedral rotating mirror is utilized to the maximum extent, a larger number of scanning lines are achieved by utilizing relatively few laser sources, the signal intensity is enhanced, light crosstalk from emission to reception is reduced, and thus, the ranging capability of the LiDAR device is improved.

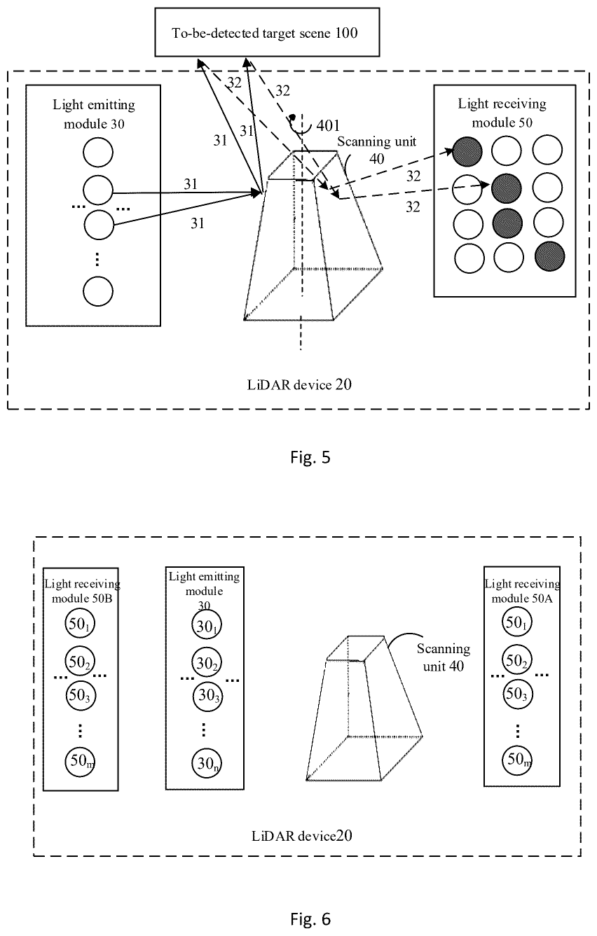

FIG. 5 is a schematic diagram for further illustrating a ranging scene of a LiDAR device according to an embodiment of the present disclosure.

As shown in FIG. 5, first light signals emitted by the plurality of different light emitting units are reflected towards a to-be-detected target scene by a first reflecting mirror surface among the plurality of reflecting mirror surfaces, and second light signals reflected by a target object in the to-be-detected target scene are reflected by a second reflecting mirror surface among the plurality of reflecting mirror surfaces to finally reach at least one light receiving unit in the at least one light receiving module. The plurality of light receiving units are arranged in an area array, wherein parts of the light receiving units (represented to be filled in FIG. 5) arranged along a curve are disposed in a working mode, and at least one light receiving unit (represented to be unfilled in FIG. 5) is disposed in a non-working mode. That is, the processing unit can accurately select the light receiving unit required to be in the working mode according to control signals sent to the light receiving module and configured to control the plurality of different light receiving units, thereby further increasing the working efficiency of the LiDAR device.

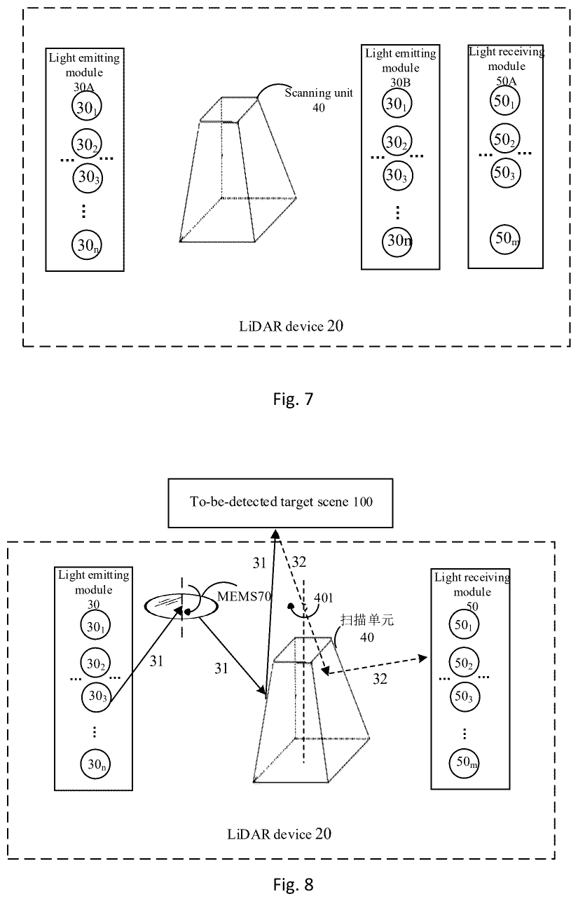

FIG. 6 and FIG. 7 are block diagrams for illustrating the configuration of a LIDAR device according to an embodiment of the present disclosure.

As shown in FIG. 6, the at least one light receiving module includes a first light receiving module 50A and a second light receiving module 50B, the first light receiving module 50A is disposed on a first side relative to the scanning unit 40, the second light receiving module 50B is disposed on a second side relative to the scanning unit, and the first side is different from the second side. The light emitting module 30 can be disposed on either the first side or the second side, for example. By the configuration of the LiDAR device shown in FIG. 6, after being scanned by the scanning unit 40, emitted light from the light emitting module 30 can be received by each of the plurality of light receiving modules 50A and 50B located on the different sides, and thus, the receiving area of the LiDAR device is further increased.

As shown in FIG. 7, the at least one light emitting module includes a first light emitting module 30A and a second light emitting module 30B, the first light emitting module 30A is disposed on a first side relative to the scanning unit 40, the second light emitting module 30B is disposed on a second side relative to the scanning unit 40, and the first side is different from the second side. The light receiving module 50 can be disposed on either the first side or the second side, for example. By the configuration of the LiDAR device shown in FIG. 7, after being scanned by the scanning unit 40, emitted light from the first light emitting module 30A and the second light emitting module 30B that are located on the different sides can be received by the light receiving module 50, and thus, the receiving area of the LiDAR device is further increased.

FIG. 8 is a schematic diagram for further illustrating a ranging scene of a LiDAR device according to an embodiment of the present disclosure. The LiDAR device 20 shown in FIG. 8 is further equipped with at least one micro-electro-mechanical system (MEMS) micromirror 70. That is, the MEMS micromirror 70 and the scanning unit 40 jointly perform a scanning operation of the LiDAR device 20. A scanning direction of the MEMS micromirror 70 is different from a scanning direction of the scanning unit 40.

In one embodiment of the present disclosure, a mirror surface of the MEMS micromirror 70 swings back and forth in the vertical direction, such that the first light signal emitted by the light emitting module 30 in the vertical direction forms field of view scanning. As described above, the scanning unit 40 rotates around the rotation axis in the vertical direction, such that the first light signal scanned by the MEMS micromirror 70 forms field of view scanning in the horizontal direction. That is, by jointly performing the scanning operation of the LiDAR device 20 by the MEMS micromirror 70 and the scanning unit 40, the range of the field of view of the LiDAR device 20 is further extended.

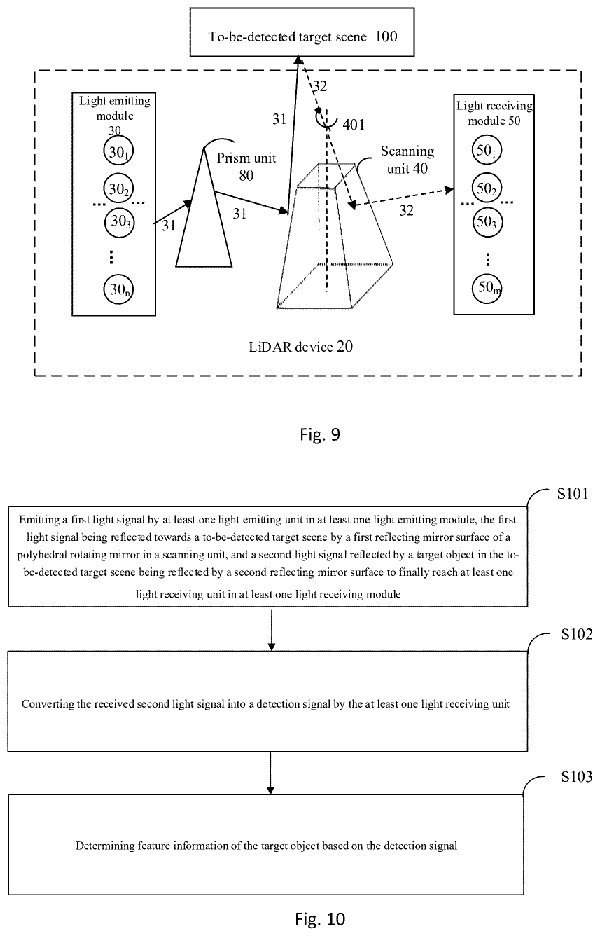

FIG. 9 is a schematic diagram for further illustrating a ranging scene of a LIDAR device according to an embodiment of the present disclosure. The LiDAR device 20 shown in FIG. 9 is further equipped with a prism unit 80. The prism unit 80 is disposed between the at least one light emitting module 30 and the scanning unit 40 and is configured to adjust a direction in which the first light signal 31 is incident on the scanning unit.

That is, by disposing the prism unit 80 in an emitting light path of the LiDAR device 20, impacts of emitting angle changes of the first light signal 31 emitted by the light emitting module 30 on the subsequent light path can be reduced, and thus, the stability and vibration resistance of the LiDAR device 20 are enhanced.

FIG. 10 is a flow diagram for illustrating a feature information determination method according to an embodiment of the present disclosure. The feature information determination method shown in FIG. 10 can be performed by the above-mentioned LiDAR device 20 described with reference to FIG. 2 to FIG. 9.

In step S101, a first light signal is emitted by at least one light emitting unit in at least one light emitting module, the first light signal being reflected towards a to-be-detected target scene by a first reflecting mirror surface of a polyhedral rotating mirror in a scanning unit, and a second light signal reflected by a target object in the to-be-detected target scene being reflected by a second reflecting mirror surface to finally reach at least one light receiving unit in at least one light receiving module.

As described above with reference to FIG. 2 to FIG. 9, an angle between each reflecting mirror surface of the polyhedral rotating mirror and a rotation axis of the polyhedral rotating mirror is an inclination angle of the reflecting mirror surface, the first reflecting mirror surface has a first inclination angle, the second reflecting mirror surface has a second inclination angle, and the first inclination angle is different from the second inclination angle. An inclination angle difference of adjacent reflecting mirror surfaces among the plurality of reflecting mirror surfaces is a predetermined value. The correspondence between the first light emitting unit and the first light receiving unit is determined by the first inclination angle of the first reflecting mirror surface and the second inclination angle of the second reflecting mirror surface.

The cross section of the polyhedral rotating mirror is of a regular polygon, and the number of sides of the regular polygon is an integer multiple of 4. During any received and emitted light detection, a light receiving field of view to which all the light receiving units in the at least one light receiving module can correspond is greater than a light receiving field of view to which all the light emitting units in the at least one light emitting module can correspond. An intersection line of the first reflecting mirror surface and a vertical cross section of the rotation axis is perpendicular to an intersection line of the second reflecting mirror surface and the vertical cross section of the rotation axis. More specifically, the plurality of light receiving units are arranged in an area array, wherein parts of the light receiving units arranged along a curve are disposed in a working mode, and at least one light receiving unit is disposed in a non-working mode. The number of the light receiving units in the at least one light receiving module is greater than the number of the light emitting units in the at least one light emitting module.

In step S102, the received second light signal is converted into a detection signal by the at least one light receiving unit.

In step S103, feature information of the target object is determined based on the detection signal, the feature information at least including distance information and/or reflectivity information of the target object.

Above, the LiDAR device, the scanning unit, the vehicle, and the feature information determination method according to the embodiments of the present disclosure are described with reference to the accompanying drawings. By using the reflecting mirror surfaces with the different inclination angles to reflect emitted light and received light, the number of scanning lines more than light sources is achieved by utilizing relatively few laser sources, moreover, the receiving area of the polyhedral rotating mirror is utilized to the maximum extent, the signal intensity is enhanced, and the ranging capability of LiDAR is improved.

The basic principles of the present disclosure have been described above in conjunction with the specific embodiments. However, it should be pointed out that the advantages, benefits, effects and the like mentioned in the present disclosure are only for the purpose of giving examples rather than limitations, and cannot be considered to be necessary for each embodiment of the present disclosure. In addition, the specific details disclosed above are only for purposes of giving examples and facilitating understanding rather than giving limitations. The above-mentioned details do not give a limitation that the present disclosure must be implemented by using the above-mentioned specific details.

Block diagrams of components, devices, equipment and systems involved in the present disclosure are only illustrative examples and are not intended to require or imply that they must be connected, arranged, or disposed in ways shown in the block diagrams. As the skilled in the art will recognize, these components, devices, equipment and systems can be connected, arranged and disposed in any way. Words such as “including”, “containing” and “having” are open-class words, refer to “including, but not limited to”, and can be used interchangeably with the same. Words “or” and “and” used herein refer to words “and/or” and can be used interchangeably with the same unless the context explicitly indicates otherwise. The word “such as” used herein refers to the phrase “such as, but not limited to” and can be used interchangeably with the same.

In addition, as used herein, “or” used in the enumeration of items starting with “at least one” indicates separate enumeration, such that the enumeration of “at least one of A, B, and C” implies A or B or C, or AB or AC or BC, or ABC (namely, A and B and C). Furthermore, the wording “exemplary” does not imply that the described example is preferred or better than other examples.

It should also be pointed out that in the system and method of the present disclosure, each component or step can be decomposed and/or recombined. These decompositions and/or combinations should be considered as equivalent solutions of the present disclosure.

Various changes, substitutions and alterations can be made to the technology described herein without departing from teachings defined by the appended claims. Furthermore, the scope of the claims of the present disclosure is not limited to specific aspects of the above-mentioned processing, machines, manufacturing, event composition, means, methods, and actions. The currently existing or later developed processing, machines, manufacturing, event composition, means, methods and actions that can achieve the essentially same functions or results as the corresponding aspects described herein can be utilized. Therefore, the appended claims include such processing, machines, manufacturing, event composition, means, methods and actions within their scope.

The above description of the disclosed aspects is provided such that any skilled in the art can make or use the present disclosure. Various modifications in these aspects are very apparent to those skilled in the art, and general principles defined herein can be applied to other aspects without departing from the scope of the present disclosure. Therefore, the present disclosure is not intended to be limited to the aspects shown herein, but is in accordance with the widest scope consistent with the principles and novel features disclosed herein.

The above description has been provided for the purposes of illustration and description. Furthermore, this description is not intended to limit the embodiments of the present disclosure in the form disclosed herein. Although a plurality of example aspects and embodiments have been discussed above, those skilled in the art will recognize certain variations, modifications, alterations, additions, and sub-combinations thereof.

1. A LIDAR device, comprising at least one light emitting module composed of one or more light emitting units, at least one scanning unit, at least one light receiving module composed of one or more light receiving units, and a processing unit;
at least one light emitting unit in the at least one light emitting module being configured to emit a first light signal;
the scanning unit at least comprising a polyhedral rotating mirror that rotates around a rotation axis, the polyhedral rotating mirror having a plurality of reflecting mirror surfaces, the first light signal being reflected towards a to-be-detected target scene by a first reflecting mirror surface among the plurality of reflecting mirror surfaces, a second light signal reflected by a target object in the to-be-detected target scene being reflected by a second reflecting mirror surface among the plurality of reflecting mirror surfaces to finally reach at least one light receiving unit in the at least one light receiving module, and during any received and emitted light detection, a light receiving field of view to which all the light receiving units in the at least one light receiving module can correspond being greater than a light receiving field of view to which all the light emitting units in the at least one light emitting module can correspond;
the at least one light receiving unit being configured to convert the received second light signal into a detection signal; and
the processing unit being configured to determine feature information of the target object based on the detection signal, the feature information at least comprising distance information and/or reflectivity information of the target object,
wherein an angle between each of the reflecting mirror surfaces and the rotation axis is an inclination angle of the reflecting mirror surface, the first reflecting mirror surface has a first inclination angle, the second reflecting mirror surface has a second inclination angle, and the first inclination angle is different from the second inclination angle.

2. The LiDAR device of claim 1, wherein an intersection line of the first reflecting mirror surface and a vertical cross section of the rotation axis is perpendicular to an intersection line of the second reflecting mirror surface and the vertical cross section of the rotation axis.

3. The LiDAR device of claim 1, wherein the plurality of light receiving units are arranged in an area array, wherein parts of the light receiving units arranged along a curve are disposed in a working mode, and at least one light receiving unit is disposed in a non-working mode.

4. The LiDAR device of claim 1, wherein the at least one light receiving module comprises a first light receiving module and a second light receiving module, the first light receiving module is disposed on a first side relative to the scanning unit, the second light receiving module is disposed on a second side relative to the scanning unit, and the first side is different from the second side; and light emitted by at least one of the light emitting units is at least partially received by the first light receiving module and is at least partially received by the second light receiving module.

5. The LiDAR device of claim 1, wherein the at least one light emitting module comprises a first light emitting module and a second light emitting module, the first light emitting module is disposed on a first side relative to the scanning unit, and the second light emitting module is disposed on a second side relative to the scanning unit; and at least one of the light receiving units receives at least part of emitted light from the first light emitting module and is also capable of receiving at least part of emitted light from the second light emitting module.

6. The LiDAR device of claim 1, wherein an inclination angle difference of adjacent reflecting mirror surfaces among the plurality of reflecting mirror surfaces is a predetermined value.

7. The LIDAR device of claim 1, wherein the scanning unit further comprises at least one micro-electro-mechanical system micromirror, and a scanning direction of the at least one micro-electro-mechanical system micromirror is different from a scanning direction of the polyhedral rotating mirror.

8. The LiDAR device of claim 1, further comprising a prism unit disposed between the at least one light emitting module and the scanning unit and configured to adjust a direction in which the first light signal is incident on the scanning unit.

9. The LIDAR device of claim 1, wherein the number of the light receiving units in the at least one light receiving module is greater than the number of the light emitting units in the at least one light emitting module.

10. The LiDAR device of claim 9, wherein a first light emitting unit in the at least one light emitting module emits the first light signal, the first light signal is reflected towards the to-be-detected target scene by the first reflecting mirror surface among the plurality of reflecting mirror surfaces, and the second light signal reflected by the target object in the to-be-detected target scene is reflected by the second reflecting mirror surface to finally reach the first light receiving unit in the at least one light receiving module;
wherein the correspondence between the first light emitting unit and the first light receiving unit is determined by the first inclination angle of the first reflecting mirror surface and the second inclination angle of the second reflecting mirror surface.

11. The LiDAR device of claim 1, wherein the processing unit receives external control signals from the outside of the LiDAR device and controls one or more of light emitting time, angle, intensity, code and comparator photoelectric threshold for the second light signal of the at least one light emitting unit based on the external control signals.

12. The LiDAR device of claim 1, further comprising:
at least one code wheel unit configured to output angle information corresponding to the light emitting time of the at least one light emitting unit.

13. The LiDAR device of claim 11, wherein the external control signals are provided by vehicle-related controllers.

14. The LiDAR device of claim 1, wherein parts of light emitting module control signals of the light emitting module are obtained by performing unified calculation and processing on at least three second light signals in a local area in the target scene, wherein a time interval of at least two second light signals is greater than one-fifth of one-frame scanning time, and the local area is smaller than a preset local proportion of the target scene;
the unified calculation comprises calculation performed by using a neural network; and
the parts of light emitting module control signals control at least one of the following contents: emitting time, light intensity, angle, multi-pulse interval, waveform and code of each light emitting unit.

15. The LiDAR device of claim 14, wherein the unified calculation is provided by the vehicle-related controllers.

16. A scanning unit, comprising:
a polyhedral rotating mirror that rotates around a rotation axis, the polyhedral rotating mirror having a plurality of reflecting mirror surfaces, a first light signal being reflected towards a to-be-detected target scene by a first reflecting mirror surface among the plurality of reflecting mirror surfaces, and a second light signal reflected by a target object in the to-be-detected target scene being reflected by a second reflecting mirror surface among the plurality of reflecting mirror surfaces;
wherein an angle between each of the reflecting mirror surfaces and a plane perpendicular to the rotation axis is an inclination angle of the reflecting mirror surface, the first reflecting mirror surface has a first inclination angle, the second reflecting mirror surface has a second inclination angle, and the first inclination angle is different from the second inclination angle.

17. The scanning unit of claim 16, wherein an intersection line of the first reflecting mirror surface and a vertical cross section of the rotation axis is perpendicular to an intersection line of the second reflecting mirror surface and the vertical cross section of the rotation axis.

18. The scanning unit of claim 16, wherein an inclination angle difference of adjacent reflecting mirror surfaces among the plurality of reflecting mirror surfaces is a predetermined value.

19. The scanning unit of claim 16, further comprising at least one micro-electro-mechanical system micromirror, and a scanning direction of the at least one micro-electro-mechanical system micromirror is different from a scanning direction of the polyhedral rotating mirror.

20. A vehicle, comprising the LiDAR device of claim 1.

21. (canceled)
